(19) United States
(12) Patent Application Publication
(10) Pub. No.: US 2012/0031687 A1
(43) Pub. Date: Feb. 9, 2012

(54) AUXILIARY POWER UNIT HAVING SELF-CONTAINED ELECTRIC POWER DISTRIBUTION

(75) Inventors: Allen G Renfrow, Fort Wayne, IN (US); Yogesh Dharmadhikari, Maharashtra (IN); Sabrina Omar, Fort Wayne, IN (US); Charles Howard, Silver Lake, IN (US); Pankaj Kumar, Bangalore (IN); Sachin Pandit, Pune (IN)

(73) Assignee: International Truck Intellectual Property Company, LLC, Warreville, IL (US)

(21) Appl. No.: 13/121,380

(22) PCT Filed: Sep. 29, 2008
(86) PCT No.: PCT/IN08/00631

§ 371 Date: Jun. 16, 2011

(51) Int. Cl. B60K 25/00

(52) U.S. Cl. 180/53.8; 307/10.1

(57) ABSTRACT

An enclosure (10) contains an APU (12) and an electrical distribution system (14) to form a self-contained module that can be mounted at any suitable location on a truck's exterior, eliminating significant portions of the wire/cable routing that would otherwise typically be required.

### FIELD OF THE INVENTION

This invention relates generally to electrical systems of motor vehicles, especially large motor vehicles like highway trucks. More particularly, the invention relates to a truck that has an auxiliary power unit (APU) for generating AC electric power.

### BACKGROUND OF THE INVENTION

A highway truck that has a sleeper cab may also have an APU that generates electric power, typically at times when the engine that propels the truck is shut off. Because the engines of most highway trucks use diesel fuel, the engine in a typical APU is a diesel engine that draws diesel fuel from the truck's fuel tanks.

The APU diesel engine powers an electric generator that develops typical household AC voltage, regulated 120 VAC, 60 hz. Electrical devices and accessories, many of which would be considered common household accessories, can be plugged into receptacles in a truck sleeper compartment that are connected to the regulated AC voltage. The regulated AC voltage can also be used to charge the truck's battery bank.

Various APU models are commercially available from different manufacturers. A truck manufacturer or user who wants to equip a truck with an APU must determine an appropriate mounting location for the unit. The manufacturer/user must also determine an appropriate mounting location for a power control unit that is needed to interface the APU with the vehicle's electrical system, and must then make various wiring connections between the units and various connections with the vehicles electrical system.

The routing of wiring on a truck can be an added expense of incorporating an APU in the truck because of the amount of wiring needed and the time required to install the wiring and both units. Out of necessity and/or because of space limitations, the wiring may have to be routed in locations where shielding and/or other extra protection is needed.

### SUMMARY OF THE INVENTION

One aspect of the present invention relates to a more convenient and efficient way to incorporate an APU in a large truck. This improvement is accomplished by making the electric power distribution system self-contained within an APU.

This eliminates significant portions of the wire/cable routing that would typically be required when an APU and power distribution unit are separate modules mounted at different locations in a truck.

In accordance with the present invention, a battery charger, Automatic Transfer Swtich (ATS), fuses, relays, wiring, and other devices are arranged inside an enclosure that further houses a diesel engine that operates an AC generator as an APU.

One general aspect of the invention relates to a truck comprising a DC electrical system comprising a battery bank, a diesel engine for propelling the truck, and a cab that includes a sleeper compartment.

An APU comprises an enclosure containing a) an AC generator driven by an auxiliary diesel engine for providing auxiliary electric power for the truck, b) a controller for the auxiliary engine, and c) an electrical distribution system for distributing electric power within the enclosure to satisfy electrical loads in the truck remote from the enclosure by selectively using external shore power and auxiliary power from the generator.

The electrical distribution system comprises an automatic transfer switch for switching AC shore power to the electrical loads when shore power is being supplied to the enclosure and switching the electrical loads to auxiliary power from the generator when shore power is not being supplied to the enclosure, and a battery charger operated either by auxiliary electric power from the generator or shore power for charging the battery bank

The foregoing, along with further aspects, features, and advantages of the invention, will be seen in the following disclosure of a presently preferred embodiment of the invention depicting the best mode contemplated at this time for carrying out the invention. The disclosure includes a drawing, briefly described as follows.

### BRIEF DESCRIPTION OF THE DRAWINGS

FIGS. 1A and 1B show an arrangement of components within the interior of an enclosure in accordance with principles of the invention, the views being from different directions.

FIG. 2 is a schematic diagram showing various devices related to the invention in a truck.

FIG. 3 is a schematic diagram relating components within the interior of the enclosure to each other and to certain external devices.

### DESCRIPTION OF THE PREFERRED EMBODIMENT

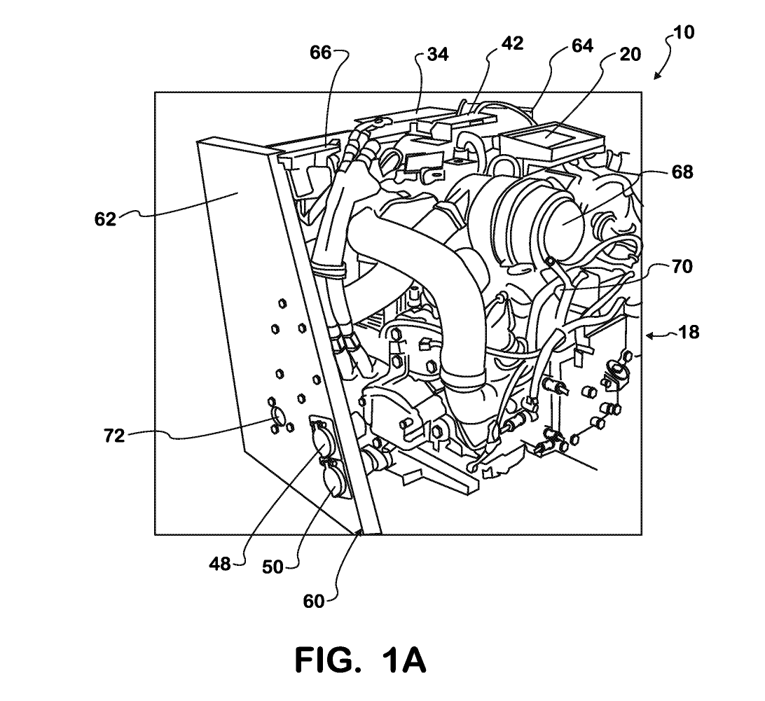

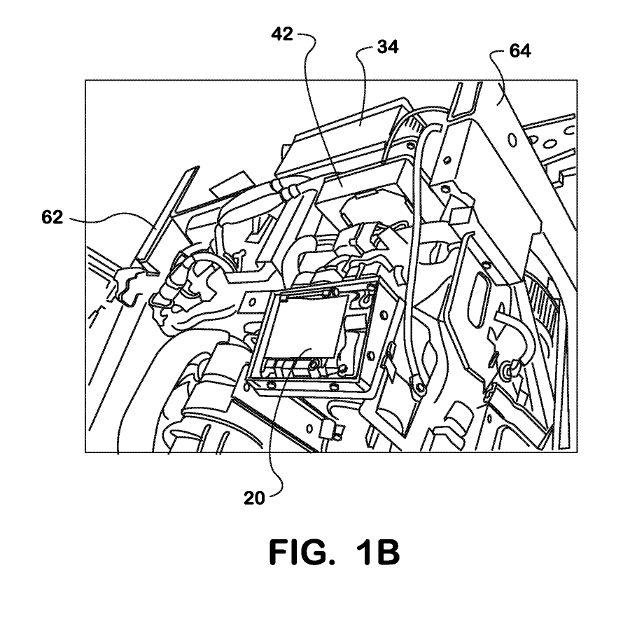

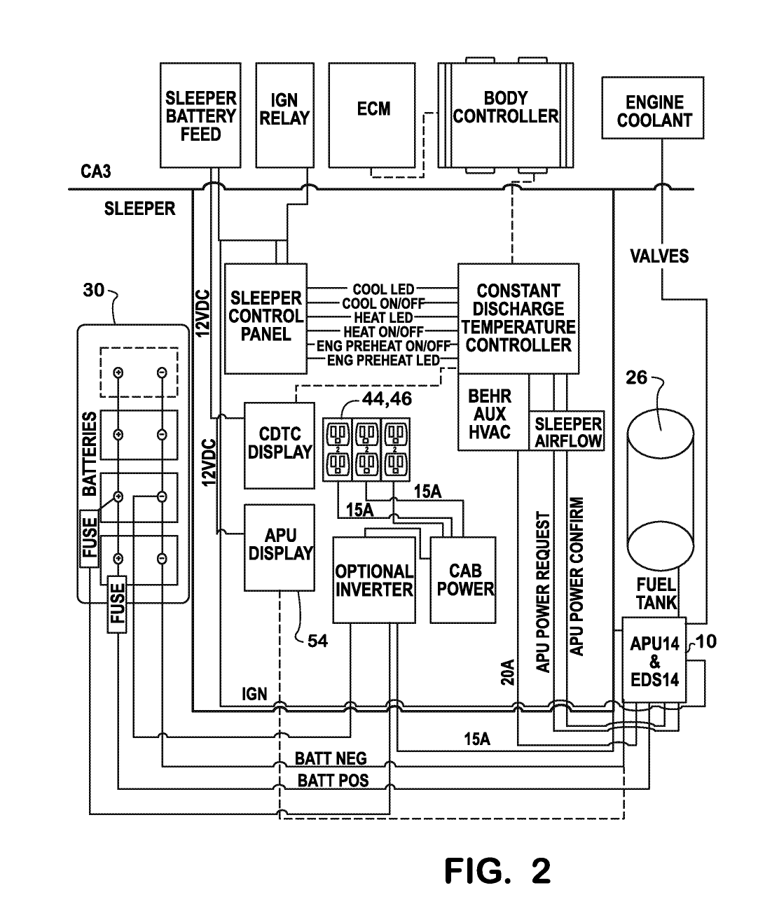

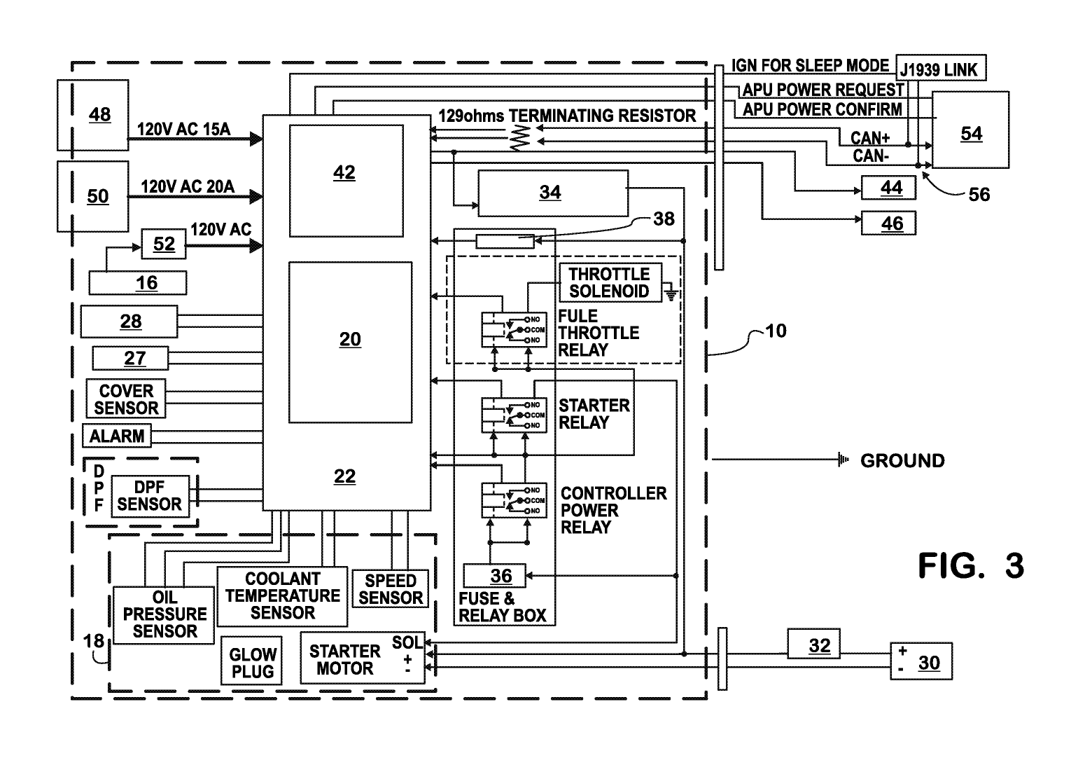

The drawings show a module 10 within which are disposed an APU 12 and an electrical distribution system (EDS) 14 in accordance with principles of the present invention. Module 10 is entirely self-contained for mounting at any suitable location on a truck's exterior. FIGS. 1A and 1B show the module's cover having been removed so that the interior components can be seen.

APU 12 comprises an AC generator 16 driven by an auxiliary diesel engine 18 for providing auxiliary electric power for the truck. A controller 20 for auxiliary engine 18 is mounted on a power distribution board 22. Engine 18 comprises various conventional electrical devices that include an oil pressure sensor, a coolant temperature sensor, a speed sensor, glow plugs, and a starter motor. A DPF sensor is associated with a diesel particulate filter in the engine exhaust system.

A fuel line 24 runs from engine 18 to one of the truck's fuel tanks 26 that holds fuel for the diesel engine that propels the truck. Fuel is pumped to engine 18 via a fuel pump 27. The truck's coolant system provides coolant for auxiliary engine 18 that is circulated by an electric operated coolant pump 28.

The truck's battery bank 30 is connected via a fuse 32 with the engine starter motor and with a battery charger 34 that is a component of electrical distribution system 14. Within module 10 battery power is supplied through a fuse 36 to a power controller relay and through a fuse 38 to power distribution board 22. Battery power is supplied directly to a starter relay. Fuses 36, 38, the power controller relay, the starter relay, and a fuel throttle relay are all disposed inside a fuse and relay box 40 within module 10.

Electrical distribution system 14 distributes electric power within module 10 to satisfy electrical AC loads 44, 46 in the truck remote from the module by selectively switching external AC shore power and auxiliary AC power from generator 16. The switching is performed by an automatic transfer switch (ATS) 42. When shore power is being supplied to module 10 via a respective plug connected into one both receptacles 48, 50, ATS 42 switches the electrical AC loads to shore power. When shore power is not being supplied to the receptacles, generator 16 supplies regulated AC via a regulator 52.

Battery bank 30 is typically kept charged by the truck's alternator. However, when the truck's engine is not running, battery charger 34 can keep the battery bank charged via either shore power or generator 16 when the latter is being operated by auxiliary engine 18.

An interface 54 within the sleeper compartment of a truck cab communicates with APU 12 and electrical distribution system 14 via a CAN data link 56 using a defined protocol. When a person uses the interface to start APU 12, an APU power request message is issued by the interface. Upon regulated AC power being generated, an APU Power Confirm message is sent to the interface.

The module comprises a structural frame 60 having metal uprights 62, 64, preferably steel, at opposite sides as shown in FIGS. 1A and 1B. A horizontal beam 66 bridges the upper ends of the two uprights.

The battery charge is unique in that it can produce 75A of current in an environment of 85° C. with no ventilation. Power distribution system 14 has a capacity of 6 KW.

For enabling battery charger 34 to perform in such an environment, the circuitry is housed within its own metal enclosure, preferably aluminum, that mounts directly against a face of beam 66. Flow of heat generated internally of the battery charger occurs through the aluminum enclosure to the steel beam.

FIGS. 1A and 1B show engine 18 to have an airfilter housing with an air inlet 70 that is open to the exterior of the module when the module's cover is in place.

Upright 62 has a hole 72 through which engine exhaust passes out of the module. Upright 62 also serves to mount receptacles 48, 50 for shore power input to the module.

While a presently preferred embodiment of the invention has been illustrated and described, it should be appreciated that principles of the invention are applicable to all embodiments that fall within the scope of the following claims.

What is claimed is:

1. A truck comprising:
a DC electrical system comprising a battery bank;
a diesel engine for propelling the truck;
a cab that includes a sleeper compartment;
an APU comprising an enclosure containing a) an AC generator driven by an auxiliary diesel engine for providing auxiliary electric power for the truck, b) a controller for the auxiliary engine, and c) an electrical distribution system for distributing electric power within the enclosure to satisfy electrical loads in the truck remote from the enclosure by selectively using external shore power and auxiliary power from the generator;
the electrical distribution system comprising an automatic transfer switch for switching AC shore power to the electrical loads when shore power is being supplied to the enclosure and switching the electrical loads to auxiliary power from the generator when shore power is not being supplied to the enclosure, and a battery charger operated either by auxiliary electric power from the generator or shore power for charging the battery bank.

2. A truck as set forth in claim 1 including one or more AC circuit breakers disposed within the enclosure through which AC current from either the AC shore power or the AC generator is supplied to the external electrical loads.

3. A truck as set forth in claim 1 including an interface within the cab communicating with the APU and the electrical distribution system via a CAN data link using a defined protocol.

4. A truck as set forth in claim 1 wherein the APU comprises a metal frame, and the battery charger is housed within a metal box that is mounted in surface-to-surface contact with the metal frame.

5. A truck as set forth in claim 4 wherein the metal frame of the APU comprises spaced apart uprights bridged by a metal beam, and the battery charger metal box is mounted in surface-to-surface contact with the metal beam.

6. An APU for supplying electrical power to a truck that has a sleeper compartment comprising:
an enclosure containing a) an AC generator driven by an auxiliary diesel engine for providing auxiliary electric power for the truck, b) a controller for the auxiliary engine, and c) an electrical distribution system for distributing electric power within the enclosure to satisfy electrical loads in the truck remote from the enclosure by selectively using external shore power and auxiliary power from the generator;
the electrical distribution system comprising an automatic transfer switch for switching AC shore power to the electrical loads when shore power is being supplied to the enclosure and switching the electrical loads to auxiliary power from the generator when shore power is not being supplied to the enclosure, and a battery charger operated either by auxiliary electric power from the generator or shore power for charging the battery bank.

7. An APU as set forth in claim 6 including one or more AC circuit breakers disposed within the enclosure through which AC current from either the AC shore power or the AC generator is supplied to the external electrical loads.

8. An APU as set forth in claim 6 including CAN data link port for communicating with an interface in the cab using a defined protocol.

9. An APU as set forth in claim 6 comprising a metal frame, and wherein the battery charger is housed within a metal box that is mounted in surface-to-surface contact with the metal frame.

10. An APU as set forth in claim 9 wherein the metal frame comprises spaced apart uprights bridged by a metal beam, and the battery charger metal box is mounted in surface-to-surface contact with the metal beam.
